(19) United States
(12) Patent Application Publication
(10) Pub. No.: US 2016/0009114 A1
(43) Pub. Date: Jan. 14, 2016

(54) BASE PAPER FOR DECORATIVE COATING MATERIALS

(71) Applicant: SCHOELLER TECHNOCELL GMBH & CO.KG, Osnabrück (DE)

(72) Inventors: Thomas Leifert, Osnabruck (DE); Rijk van der Zwan, Bad Iburg (DE); Michael Krause, Osnabruck (DE); Andreas Fehlker, Osnabruck (DE)

(21) Appl. No.: 14/768,568

(22) PCT Filed: Feb. 12, 2014
(86) PCT No.: PCT/EP2014/052682

§ 371 Date: Aug. 18, 2015

(30) Foreign Application Priority Data
Feb. 20, 2013 (EP) 13155977.5

(51) Int. Cl. B41M 5/52; D21H 19/40; D21H 19/38; B41J 11/00

(52) U.S. Cl. CPC B41M 5/5218; B41J 11/0015; D21H 19/40; D21H 19/385

(57) ABSTRACT

A base paper for decorative coating materials having a base paper which is not internally sized comprises a surface application to the base paper which contains an alkaline earth salt and which is substantially free of polymeric binding agent; the base paper is printable by inkjet methods and can be impregnated with a thermally curable impregnation resin.

### TECHNICAL FIELD OF THE INVENTION

The invention relates to a base paper for decorative coating materials, which can be impregnated with a thermally curable impregnation resin and printable by inkjet methods, to the use of the base paper to produce decorative coating materials, and to a method for producing coating materials using the base paper.

### BACKGROUND OF THE INVENTION

Decorative papers are required for producing decorative laminates which are used as construction materials in furniture production and interior fittings. The decorative laminates are primarily high-pressure laminates (HPLs) and low-pressure laminates (LPLs). To produce a high-pressure laminate, the decorative paper, in the unprinted or printed state, is impregnated with a resin and pressed together with one or more layers of kraft paper sheets, which have been soaked in phenol resin (core papers), in a laminating press at a temperature of from approximately 110 to 170° C. and a pressure of from approximately 5.5 to 11 MPa. Subsequently, the resulting layer material (HPL) is bonded or glued to a support material such as HDF board or chipboard. A low-pressure laminate is produced by directly pressing the unprinted or printed decorative paper, impregnated with a resin, with the support board at a temperature of from approximately 160 to 200° C. and a pressure of from approximately 1.25 to 3.5 MPa.

The finishing of material surfaces may be of an optical nature (by corresponding colouring) and/or of a physical nature (by coating the board surface having corresponding functionality and structure). Decorative papers may be processed with or without a printed pattern. For this purpose, the printed or unprinted decorative paper is conventionally soaked with synthetic resins in one or more stages, is subsequently dried, the resin still remaining reactive, and is subsequently irreversibly hot-pressed, in sheets or rolls, together with a support material. The resin cures during the pressing. As a result of this curing, not only is bonding to the board provided, but the paper is fully physically and chemically sealed. Suitable synthetic resins are the impregnation resins conventionally used in this technical field, in particular melamine formaldehyde resin, urea formaldehyde resin, phenol formaldehyde resin, polyacrylates and acrylic acid ester styrene copolymers. The impregnation resin may be used in an amount of from 40 to 250%, preferably from 80 to 125%, based on the grammage of the decorative base paper.

The printed pattern is conventionally applied by gravure printing. In particular when producing commercially available printed patterns, this printing technique has the advantage of being able to print large amounts of paper at a high machine speed.

However, gravure printing is not cost-effective for smaller amounts of decorative paper and is not sufficient in terms of print quality in the case of complicated patterns. Of the printing techniques which meet the flexibility and quality requirements, inkjet printing is therefore gaining increasing significance.

To make decorative base papers printable by inkjet printing, they are coated with one or more functional layers for receiving the ink and fixing the dyes. Decorative base papers of this type which are printable by inkjet printing are disclosed for example in DE 199 16 546 A1 and EP 1 044 822 A1.

The ink-receiving layers generally contain pigments, water-soluble or water-dispersible polymers as binding agents, dye-fixing substances, and further auxiliary substances conventionally used in layers of this type.

However, decorative base papers have fundamentally different properties from normal commercially available inkjet papers. Decorative base papers should have an open surface so as to be able to be soaked through rapidly and uniformly with an impregnation resin.

Although a decorative base paper provided with one of the above-described ink-receiving layers has good inkjet printability, it has a largely covered paper structure at least on one side of the paper. The gaps between the fibres are largely closed and are thus only available to a limited extent for receiving impregnation resins.

EP 1 749 626 A1 therefore proposes a method in which the base paper provided with an ink-receiving layer is impregnated from the rear side. WO 2009/097986 A1 proposes applying the dye-receiving mass, the primary components of which are barium sulfate, titanium dioxide and silicates, as a coating in such a way that a closed planar layer is not produced and the gaps between fibres thus remain largely open. A drawback of this procedure is that it is not possible to achieve a sufficient printing result.

EP 2 537 981 A1 discloses a method for treating the surface of an inkjet paper with a surface treatment medium containing magnesium sulfate and polydiallyldimethylammonium chloride polymer. The inkjet paper contains between 0 and 50% by weight, in particular 10 and 30% by weight CaCO₃ as a filler. As a result of using the film-forming polydiallyldimethylammonium chloride polymer in the surface treatment medium, the pores are largely sealed after the application thereof. It would thus only be possible to receive an impregnation resin to a limited extent. Further, the papers of EP 2 537 981 would be largely transparent after impregnation with an impregnation resin because of the low refractive index of calcium carbonate.

DE 698 04 233 T2 discloses a composition for the surface treatment of a substrate for inkjet printing, the composition substantially consisting of an aqueous sizing medium containing starch, a sizing agent and a salt of a divalent metal. A drawback is that the application of the aqueous sizing medium causes most of the pores on the paper surface to become sealed, and the impregnation of the paper is thus only possible to a limited extent.

### SUMMARY OF THE INVENTION

It is therefore an object of the invention to provide a base paper for decorative coating materials which does not exhibit the above-described disadvantages and which has a sufficient impregnability in spite of a high printability on one side by means of a digital printing method, in particular an inkjet printing method.

This object is achieved by a base paper for decorative coating materials, comprising a base paper which is not internally sized, the base paper having a surface application which contains an alkaline earth salt and is substantially free of polymeric binding agent.

The invention further relates to the use of the base paper according to the invention to produce laminated materials and laminates of all types.

The invention further relates to a method for producing a decorative coating material in which a base paper which is not internally sized is provided with a surface application which contains an alkaline earth salt, and the paper is printed by a digital printing method, impregnated with a thermoplastic resin and dried. The impregnated and dried paper can be varnished.

Surprisingly, it has been found that, even without a polymeric binding agent, the surface application according to the invention provides good printability by means of digital printing methods, in particular inkjet printing, and the problem of pigments “powdering”, to be expected due to the lack of binding agent, does not occur. However, the paper surface is largely free and open for receiving the impregnation agent.

A further advantage of omitting polymeric binding agents is a lower viscosity of the application liquid and thus simplification of the application method and the cleaning of the application units.

### DESCRIPTION OF PREFERRED EMBODIMENTS

Particularly suitable alkaline earth salts are alkaline earth halides and alkaline earth nitrates having a solubility in water of at least 400 g/l (measured at 20° C.). These may also be used in a mixture. The use of calcium chloride, magnesium nitrate or mixtures thereof is particularly preferred.

The effect according to the invention is achieved in particular when the surface application additionally contains an inorganic pigment having a specific BET surface area of from 100 to 400 cm²/g. Inorganic pigments having a specific surface area of from 200 to 330 cm²/g are particularly preferred. Preferred inorganic pigments of this type are for example aluminium oxide, aluminium hydroxide, boehmite and/or silica. Of the silicas, a cationised pyrogenic silica is particularly preferred.

The alkaline earth salt/pigment mass ratio in the surface application may be from 70:30 to 30:70, preferably from 60:40 to 40:60.

The surface coating may also contain further auxiliary agents such as dispersing auxiliary agents, dye fixing substances such as polyaluminium salts, polyammonium salts, pH regulating agents and other auxiliary substances conventional in the paper industry. Preferably, the surface application is substantially free of a polymeric binding agent. Substantially free means less than 5% by weight, preferably less than 3% by weight and in particular free of organic film-forming polymer.

The surface application may take place using application units conventional in paper coating. In particular “inline” application is possible in the paper machine using a size press. The application weight may preferably be from 1 to 10 g/m², in particular from 2 to 8 g/m², based on the mass of the dry substance.

The surface of the base paper according to the invention may have a pH of from 4.5 to 8, preferably from 6 to 7.

As a result of the surface of the decorative base paper being treated with the surface application according to the invention, sufficient impregnability of the base paper is achieved and the paper is given very good printability for inkjet printing. The base papers produced according to the invention have a Gurley air permeability of less than 25 s/hml, in particular from 10 to 22 s/hml.

The base paper according to the invention may be rolled up or divided into sheets. The base paper can subsequently be printed at a high quality by a wide range of inkjet methods. In a following step, the printed paper may subsequently preferably be soaked with an impregnation resin, in particular a melamine resin, and dried. The base paper can subsequently be pressed hot onto a wooden material board or into the form of a layered substance in a coating press. Optionally, transparent, unprinted and resin-treated paper (overlay or underlay) may be used as further layers in the compound as a protective and/or adhesive layer in this case. Alternatively, however, it is also possible to use another adhesive layer. The printed product may also be sealed using a varnish.

The decorative base papers which may be used according to the invention are those which have been neither internally sized nor surface-sized. These papers substantially consist of pulps, pigments and fillers and conventional additives. Conventional additives may be wet strength agents, retention agents and fixing agents. Decorative base papers differ from conventional papers on account of the much higher filler proportion or pigment content and the absence of internal sizing or surface sizing which is conventional for paper. Usually, the decorative base papers which may be used according to the invention contain a wet strength agent.

To produce the decorative base papers, softwood pulps, hardwood pulps or mixtures of the two types of pulp may be used. The use of 100% hardwood pulp is preferred. However, mixtures of softwood/hardwood pulps in a ratio of from 5:95 to 50:50, in particular from 10:90 to 30:70, may also be used. The base papers may be produced on a Fourdrinier paper machine or a Yankee paper machine. For this purpose, the pulp mixture may be ground at a consistency of from 2 to 5% by weight up to a freeness of from 10 to 45° SR. In a mixing vat, fillers and/or pigments, colour pigments and/or dyes, as well as wet strength agents such as polyamide/polyamine epichlorohydrin resin, cationic polyacrylates, modified melamine formaldehyde resin or cationised starches may be added in amounts conventional in the production of decorate papers and mixed thoroughly with the pulp mixture.

The fillers and/or pigments may be added in an amount of up to 55% by weight, in particular from 10 to 45% by weight, based on the weight of the pulp. Suitable pigments and fillers are for example titanium dioxide, talc, modified titanium dioxide and mixtures thereof.

The thick substance produced in the mixing vat can be diluted to a consistency of approximately 1%. If required, further auxiliary substances such as retention agents, antifoaming agents, dyes and other aforementioned auxiliary substances or mixtures thereof may be added. This diluted substance is passed via the headbox of the paper machine onto the wire section. A non-woven fabric is formed and after draining the base paper is obtained and is subsequently further dried. The grammage of the papers produced may be from 30 to 200 g/m².

Depending on the intended application and the quality requirements for this application, the decorative base papers used according to the invention may have the following properties:
smooth, in other words having a Bekk smoothness over 80 s,
alternatively unsmoothed having a Bekk smoothness of <80 s,
smoothed using a Yankee dryer or using a calender,
high air permeability having Gurley values below 20 s/hml or denser having Gurley values over 20 s/hml.

The decorative base paper according to the invention may be dyed. For dying, inorganic colour pigments such as metal oxides, metal hydroxides and metal oxide hydrates, metal sulfides, metal sulfates, metal chromates and metal molybdates or mixtures thereof, as well as organic colour pigments and/or dyes such as carbonyl colourants (quinones, quinacridones), cyanine colourants, azo colourants, azomethines and methines, phthalocyanines or dioxazines may be used. Mixtures of inorganic colour pigments and organic colour pigments or dyes are preferred. The mass of the colour pigment or colour pigment mixture or dye or dye mixture may be from 0.0001 to 5% by weight, based on the mass of the pulp, depending on the type of dye.

Dying the base paper according to the invention is constantly adjustable. This is more complex and requires more time and higher costs in the case of a decorative base paper coated with a separate ink-receiving layer.

In a particular configuration of the invention, the surface application liquid may contain colouring additives. These may be the same colour pigments and/or dyes with which the base paper was also dyed.

One embodiment of the invention relates to a method for producing a decorative coating material or decorative paper. For this purpose, the base paper according to the invention is printed by a digital printing method, for example by inkjet printing. The printed base paper can subsequently be impregnated with a thermoplastic resin and dried. The drying may take place in such a way that the impregnation resin is fully cured or else only partially cured. Partially cured means that the thermoplastic resin is up to 70% and more, 80% and more or 90% and more cured.

The decorative coating material or decorative paper is applied to a permanent support in a known manner under the effects of heat and pressure and optionally with additional use of an adhesive known for these purposes.

The following examples provide further explanation of the invention.

### EXAMPLES

### Example 1 (E1)

To produce the pulp suspensions, a pulp mixture of 80% eucalyptus pulp and 20% by weight pine sulphate pulp was ground at a consistency of 5% up to a freeness of 33° SR. Subsequently, 1.8% by weight epichlorohydrin resin was added as a wet strength agent. This pulp suspension was adjusted to a pH of from 6.5 to 7 using aluminium sulphate. Subsequently, a mixture of 40% by weight titanium dioxide and 5% by weight talc, 0.11% by weight of a retention auxiliary agent and 0.03% by weight of an antifoaming agent was added to the pulp suspension, and a decorative base paper having a grammage of 90 g/m² and an ash content of approximately 32% by weight was made. The weight specifications are based on the mass of the pulp. In the next step, the decorative base paper was treated with the application liquid disclosed below in the size press and subsequently dried. The application weight was 2 g/m² (dry).

Application liquid for the surface application:

| | |
|---|---|
| Water | 80% by weight |
| Calcium chloride (solid) | 20% by weight |

The pH of the application liquid had been adjusted to pH 5 using NaOH.

### Example 2 (E2)

A pulp suspension of 100% by weight eucalyptus pulp was ground at a consistency of 5% up to a freeness of 33° SR. Subsequently, 1.8% by weight epichlorohydrin resin was added as a wet strength agent. This pulp suspension was adjusted to a pH of from 6.5 to 7 using aluminium sulfate. Subsequently, a mixture of 36% by weight titanium dioxide and 5% by weight talc, 0.11% by weight of a retention auxiliary agent and 0.03% by weight of an antifoaming agent was added to the pulp suspension, and a decorative base paper having a grammage of approximately 80 g/m² and an ash content of approximately 30% by weight was made therefrom. The weight specifications are based on the mass of the pulp. In the next step, the decorative base paper was treated with the following application liquid in the size press and subsequently dried. The application weight was 6 g/m² (dry).

Application liquid for the surface application:

| | |
|---|---|
| Water | 80% by weight |
| Calcium chloride (solid) | 10% by weight |
| Pyrogenic silica(solid) | 10% by weight |
| (Aerosil ® 300, Evonik). | |

The pH of the application liquid had previously been adjusted to 5 using NaOH.

### Example 3 (E3)

A dispersion of cationised pyrogenic silica was produced as follows:

To 1 kg water at 20° C. were added 35 g of the cationic silane preparation DYNASILAN HYDROSIL® 2999 (from Evonik Industries AG) and 8 g methanesulfonic acid. To this solution were added 300 g Aerosil® 300 (Evonik Industries AG) whilst stirring vigorously, and subsequently the mixture was dispersed for 20 minutes at 9600 revolutions per minute (rpm) using a T25 ULTRA-TURRAX® rotor/stator dispersing system. The solid content of the dispersion of cationised pyrogenic silica thus produced was 22% by weight.

A decorative base paper produced according to Example 1 was impregnated with the following application liquid in the size press and subsequently dried. The application weight was 8 g/m² (dry).

Application liquid for the surface application:

| | |
|---|---|
| Water | 80% by weight |
| Magnesium nitrate (solid) | 10% by weight |
| Cationised pyrogenic | 10% by weight |
| silica (as a solid) | |

The pH of the application liquid had previously been adjusted to pH 5 using NaOH.

### COMPARATIVE EXAMPLES

### Comparative Example 1 (C1)

A decorative base paper produced according to Example 1 was used as a base paper without further application of paste.

### Comparative Example 2 (C2)

A decorative base paper produced according to Example 1 was treated with the following application liquid in the size press and subsequently dried. The application weight was 8 g/m² (dry). The cationised pyrogenic silicic acid was produced from Aerosil® 300 (Evonik Industries AG) according to Example 3.

Application liquid for the surface application:

| | |
|---|---|
| Water | 50% by weight |
| C-Film 7311 starch (Cerestar) | 30% by weight |
| Calcium chloride (solid) | 10% by weight |
| Cationised pyrogenic silica | 10% by weight |
| (Aerosil ® 300, Evonik) | |

### Comparative Example 3 (C3)

A decorative base paper produced according to Example 1 was coated with an ink-receiving layer according to the examples of EP 1 044 822 B1. The application weight was 5 g/m². The ink-receiving layer was of the following composition:

| | |
|---|---|
| 20% polyvinyl alcohol solution | 33% by weight |
| (MOWIOL 26-88, Kuraray Europe GmbH) | |
| 20% polyamine solution | 9% by weight |
| (Magnaflox 1597, BASF SE) | |
| 20% acrylic acid ester styrene polymer | 10% by weight |
| dispersion (Basoplast 265D, BASF SE) | |
| 20% amorphous silica dispersion | 48% by weight |
| (Gasil 200DF, PQ corporation) | |

### Testing Methods Used

The base papers produced according to the examples and comparative examples were printed in an inkjet printer (EPSON 4800 using pigmented inks).

The impregnability of the unprinted base papers was tested. The image quality and the ink bleed onto the rear side of the paper were evaluated for the printed base papers.

The methods used for testing the papers are described in the following.

### Gurley Air Resistance

The aim of the test is to characterise the porosity of the paper structure and thus the impregnability. The time required for a particular amount of air to flow through a paper surface at a constant pressure is measured. The measurement takes place pursuant to ISO 5636-5 using the 121D densometer from Lorenzen & Wettre. The measured values are specified in Gurley seconds/100 ml. Values lower than 25 s/hml indicate papers having very good air permeability. Values higher than 60 s/hml indicate a compacted structure and thus poor permeability.

### Colour Density

The image quality is evaluated by measuring the colour density for the primary colours cyan, magenta, yellow and black. The colour densities are measured using the SpectroEye densitometer from x-rite in incident light.

### Ink Bleed

Ink bleed is the penetration of the printing ink through to the rear side of the paper at certain points or in part. Specifically in decorative papers having high permeability, there is the risk of the printing ink penetrating the paper interior and thus bleeding through to the rear side of the sheet of paper.

Visual evaluation of the bleed behaviour is a measure of how well the ink fixes on the surface of the base paper.
+ no bleed, good ink fixing
∘ slight bleed, average ink fixing
− ink bleed through to the rear side, poor ink fixing

The test results are summarised in the following table:

| | Colour density | | | | | |
|---|---|---|---|---|---|---|
| | Cyan | Magenta | Yellow | Black | Air resistances/hml | Bleed |
| E1 | 0.40 | 0.55 | 0.63 | 0.99 | 18 | ∘ |
| E2 | 0.41 | 0.57 | 0.64 | 1.02 | 22 | + |
| E3 | 0.41 | 0.57 | 0.62 | 1.00 | 22 | + |
| C1 | 0.38 | 0.34 | 0.50 | 0.52 | 14 | − |
| C2 | 0.40 | 0.58 | 0.63 | 1.07 | 28 | + |
| C3 | 0.40 | 0.71 | 0.68 | 1.30 | 50 | + |

1. Base paper for decorative coating materials, comprising a base paper which is not internally sized, the base paper comprises a surface application which contains an alkaline earth salt and being substantially free of a polymeric binding agent.

2. Base paper according to claim 1, wherein the alkaline earth salt is a water-soluble calcium salt.

3. Base paper according to claim 1, wherein the alkaline earth salt is calcium chloride or calcium nitrate.

4. Base paper according to claim 1, wherein the surface application contains an inorganic pigment having a specific BET surface area, of from 100 to 400 cm²/g.

5. Base paper according to claim 4, wherein the specific BET surface area of the inorganic pigment is from 200 to 330 cm²/g.

6. Base paper according to claim 4, wherein the inorganic pigment is an aluminium oxide, an aluminium hydroxide, a boehmite and/or a silica.

7. Base paper according to either claim 4, wherein the inorganic pigment is a cationised pyrogenic silica.

8. Base paper according to claim 4, wherein the alkaline earth salt/inorganic pigment ratio, based on the mass, is from 60:40 to 40:60.

9. Base paper according to claim 1, wherein the surface application is applied in an amount of from 1 to 10 g/m², based on the mass of the dry substance.

10. Base paper according to claim 1, wherein the surface of the base paper has a pH of from 4.5 to 8.

11. (canceled)

12. Method for producing a decorative coating material, comprising the steps of the application of an alkaline earth salt onto the surface of a paper, which is not internally sized printing the paper that is provided with an application of an alkaline earth salt by a digital printing method, and impregnating the printed paper with a thermoplastic resin and drying the printed and impregnated paper.

13. Method for producing a decorative coating material according to claim 12, wherein the paper is impregnated with a thermoplastic resin and is dried in such a way that the thermoplastic resin is only up to approximately 80% cured.

14. Method for producing a decorative coating material according to claim 12, wherein a surface application, additionally containing an inorganic pigment having a specific BET surface area of 100 to 400 cm²/g, is applied to the base paper surface.

15. Base paper for decorative coating materials comprising a paper which is not internally sized, the base paper comprises a surface application which contains an alkaline earth salt selected calcium chloride and calcium nitrate and an inorganic pigment having a specific BET surface area of from 100 to 400 cm²/g, the surface application being substantially free of a polymeric binding agent.

16. Base paper according to claim 5, wherein the inorganic pigment is an aluminium oxide, an aluminium hydroxide, a boehmite and/or a silica.
